(19) United States
(12) Patent Application Publication
(10) Pub. No.: US 2022/0318718 A1
(43) Pub. Date: Oct. 6, 2022

(54) Supporting Personnel Changes

(71) Applicant: AIROBO Co., Ltd., Tokyo (JP)

(72) Inventor: Morihiro MATSUMOTO, Minato-ku (JP)

(21) Appl. No.: 17/220,336

(22) Filed: Apr. 1, 2021

(51) Int. Cl. G06Q 10/06

(52) U.S. Cl. CPC G06Q 10/063112

(57) ABSTRACT

A personnel transfer support device includes: a storage unit that stores definitions of (a) essential requirements to be satisfied by a personnel transfer plan, (b) optional requirements that are recommended to be satisfied by a personnel transfer plan, and (c) a cost function that quantifies the degree to which a personnel transfer plan satisfies the optional requirements, for a personnel transfer plan that assigns multiple personnel to multiple personnel posts, with a storage unit for storing the definitions; a search unit for searching for a solution that optimizes the cost function while satisfying the essential requirements; and an output unit for outputting the solution found by the search unit as the personnel change proposal.

### BACKGROUND

### Technical Field

This invention relates to a technology for supporting personnel transfers.

### Background Art

A technology for supporting planning of assignment of personnel to personnel posts, i.e., personnel transfer planning, is known in the art. For example, JP 4018381B discloses a technology for storing personnel posts in a database in correspondence with seat information, selectively displaying attribute information against seat information, and updating the database with attribute information of a selected target.

In addition, JP H11-120224 discloses a technique for creating personnel assignments using a personnel master, a job system master, and a job condition table for selecting candidates.

In the technology disclosed in JP 4018381B, the seat information is necessary to create a personnel transfer plan. In the technology disclosed in JP H11-120224, the final personnel assignment plan is determined by a human looking at a display screen, which is a complicated process. Further, when creating a personnel assignment plan, there are some requirements that must be satisfied (i.e. essential requirements) and some requirements that are preferable but not essential (i.e. optional requirements), but the optional requirements were not taken into consideration in the technologies of JP 4018381B and JP H11-120224.

In contrast, the present invention provides a technology for automatically planning personnel changes by considering optional requirements.

### SUMMARY

According to one aspect of the disclosure, there is provides a personnel transfer support device including: a storage unit that stores, for a personnel transfer proposal that assigns a plurality of personnel to a plurality of personnel posts, definitions of (a) essential requirements to be satisfied by the personnel transfer proposal, (b) optional requirements that the personnel transfer proposal is recommended to satisfy, and (c) a cost function that quantifies a degree that the personnel transfer proposal satisfies the optional requirements; a search unit that searches for a solution that optimizes the cost function while satisfying the essential requirements; and an output unit that outputs the solution found by the search unit as the personnel change proposal.

The cost function may include a plurality of items with respect to the optional requirement and weight coefficients corresponding to each of the plurality of items.

The personnel transfer support device may further includes: a back-calculation unit that calculates the weight coefficients in the cost function by inputting the personnel change data in past, wherein the search unit searches for a solution using the weight coefficients calculated backwards by the back-calculation unit.

The storage unit may further store a definition of an objective function that indicates the following: (d) at least one of a function that quantifies the variation of the attributes of the plurality of personnel in the plurality of personnel posts in the proposed personnel change, and a function that shows the number of persons to be transferred in the proposed personnel change, and the search unit may search for a solution that optimizes the sum of the objective function and the cost function while satisfying the essential requirements.

The objective function may be a function that quantifies the variation in at least one of the following attributes of the plurality of human resources: job evaluation, years of employment, and age.

The personnel post may be divided into a plurality of department branches, and the objective function may be a function that quantifies the variability of the attributes in the plurality of branches.

According to another aspect of the disclosure, there is provided a method for supporting personnel transfer, including: obtaining, by a computer system, for a personnel transfer proposal that assigns a plurality of personnel to a plurality of personnel posts, definitions of (a) essential requirements that the personnel transfer proposal must satisfy, (b) optional requirements that the personnel transfer proposal is recommended to satisfy, and (c) a cost function that quantifies the degree that the personnel transfer proposal satisfies the optional requirements; searching, by the computer system, for a solution that optimizes the cost function while satisfying the essential requirements; and outputting, by the computer system, the solution found by the search as a personnel change proposal.

According to another aspect of the disclosure, there is provided a program causing a computer to execute a process, the process including: obtaining for a personnel transfer proposal that assigns a plurality of personnel to a plurality of personnel posts, definitions of (a) essential requirements that the personnel transfer proposal must satisfy, (b) optional requirements that the personnel transfer proposal is recommended to satisfy, and (c) a cost function that quantifies the degree that the personnel transfer proposal satisfies the optional requirements; searching for a solution that optimizes the cost function while satisfying the essential requirements; and outputting the solution found by the search as a personnel change proposal.

### ADVANTAGEOUS EFFECT OF THE INVENTION

The present invention provides enables automatically planning personnel changes by considering optional requirements.

### BRIEF DESCRIPTION OF THE DRAWINGS

FIG. 1 shows a block diagram illustrating the functional structure of the support device 10.

FIG. 2 shows a block diagram illustrating the hardware configuration of the support device 10.

FIG. 3 shows an example of data in the employee database.

FIG. 4 shows an example of data in the personnel post database.

FIG. 5 shows an example of the contents of an optional requirement.

FIG. 6 shows a flowchart illustrating an overview of the operation of the support device 10.

FIG. 7 shows a flowchart illustrating the operation of the support device 10.

FIG. 8 shows an example of the coefficient matrix.

### DETAILED DESCRIPTION

### 1. Configuration

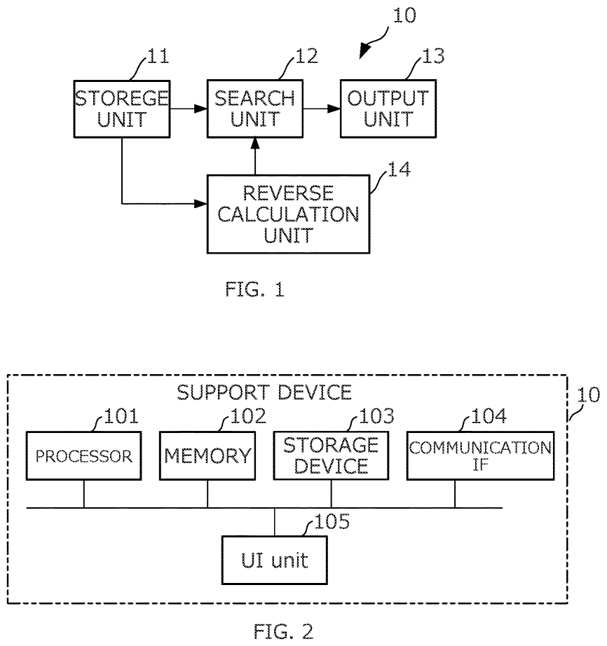

FIG. 1 shows a block diagram illustrating an exemplary functional configuration of a support device 10 (which is an example of a personnel transfer support device) according to an embodiment. The support device 10 is a device that outputs a personnel transfer plan for assigning plural personnel to plural personnel posts. The support device 10 is used by a user such as a person in charge of human resources in a company. The support device 10 is a general-purpose computer, such as a personal computer, a tablet terminal, or a smartphone.

The support device 10 includes a storage unit 11, a search unit 12, an output unit 13, and a reverse calculation unit 14. The storage unit 11 stores, with respect to a personnel transfer proposal that assigns plural human resources to plural personnel posts, (a) essential requirements that the personnel transfer proposal must satisfy, (b) optional requirements that the personnel transfer proposal is preferred (but not essential) to satisfy, (c) a cost function that quantifies a degree to which the personnel transfer proposal satisfies the optional requirements, and (d) definitions of the objective function, which quantifies the variability of the attributes of the plural personnel in the plural personnel posts.

The search unit 12 searches for a solution that optimizes the sum of the objective function and the cost function while satisfying the essential requirements. The output unit 13 outputs the solution found by the search unit 12 as a personnel change proposal. The reverse calculation unit 14 calculates the weight coefficients in the cost function backward by inputting the personnel change data in the past.

FIG. 2 shows a block diagram illustrating an exemplary hardware configuration of the support device 10. A processor 101 is a device that controls other elements of the support device 10. A memory 102 is a storage device that functions as a work area for the processor 101 to execute programs, and includes, for example, RAM (Random Access Memory). A storage 103 is a storage device that stores various programs and data, and includes, for example, a SSD (Solid State Drive) or a HDD (Hard Disk Drive). A communication IF 104 communicates with other devices according to a predetermined wireless or wired communication standard (e.g., Wi-Fi (registered trademark), Bluetooth (registered trademark), or Ethernet (registered trademark)). A UI unit 105 may be installed into the support device 10, or may be installed in an external device and connected externally.

The storage device 103 stores a program for preparing personnel transfer proposals (hereinafter referred to as the “personnel transfer support program”). When the processor 101 executes the personnel transfer support program, the functions shown in FIG. 1 are implemented by the computer. The processor 101 executing the personnel transfer support program is an example of the search unit 12, the output unit 13, and the reverse calculation unit 14. The storage device 103 is an example of the storage unit 11.

In this example, the storage unit 11 stores a personnel database (not shown in the figures). The personnel database is a database in which information about personnel is recorded. The personnel database has an employee database and a personnel post database (neither of which is shown in the figures). The employee database contains information on the attributes of employees. In the personnel post database, information indicating the attributes of personnel posts is recorded.

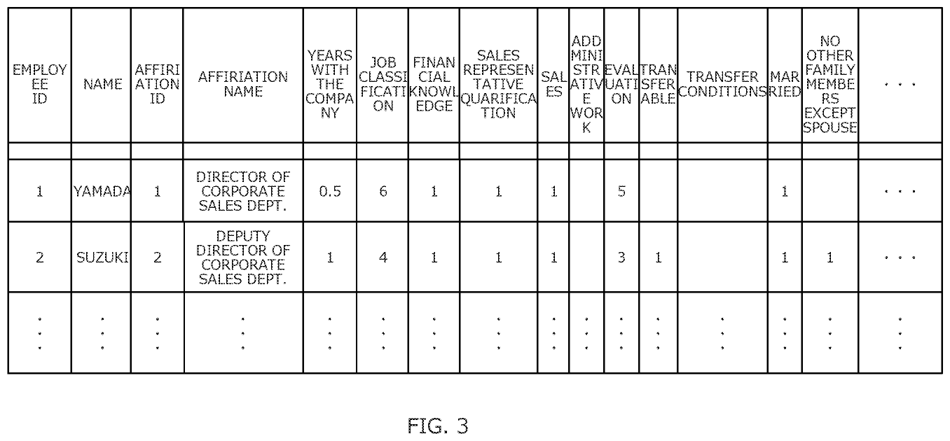

FIG. 3 shows an example of data in the employee database. In this example, the employee database has a record of information including the following items as employee attributes: “Employee ID,” “Name,” “Affiliation ID,” “Affiliation Name,” “Years with the Company,” “Job Classification,” “Financial Knowledge,” “Sales Representative Qualification,” “Responsibilities,” “Evaluation,” “Transferable,” “Transfer Conditions,” “Married,” and “No other family members except spouse”. Of these items, the “Employee ID” field records an identifier (employee ID) that identifies the employee. The “Name” field records the name of the employee. The “Affiliation ID” field records an identifier (affiliation ID) that identifies the department and position to which the employee belongs. The “Affiliation ID” field records an identifier (affiliation ID) that identifies the department and position to which the employee belongs. The “Affiliation Name” field records the name of the department and position to which the employee belongs. “Years with the organization” field records the number of years the employee has been with the organization (position). The “Classification” field records a value indicating the employee's classification.

The “Financial Knowledge” field records information that indicates whether the employee has the specified qualifications for financial knowledge. If the employee has the required qualification, “1” is recorded in the “Financial knowledge” field. On the other hand, if the person does not have the specified qualification the “Financial knowledge” field is left blank (alternatively, the value “zero” or a null string is recorded. The same applies to the fields below). The “Sales Representative Qualification” field records information indicating whether the employee has the specified Sales Representative. If the employee has the prescribed qualifications, “1” is recorded in the “Sales Representative Qualifications” field. On the other hand, if the employee does not have the prescribed qualifications, the “Sales Representative Qualifications” field is left blank.

In the “Sales” field, “1” is recorded when the employee's job is in sales, and “2” is recorded when the employee's job is not in sales, or the field is left blank. In the “Administrative” field, “1” is recorded if the employee's job is administrative work, and if the employee's job is not administrative work the field is left blank. The “Evaluation” field records information about the employee's evaluation (e.g., a five-level scale may be used) for the most recent term. The “Transferable” field is set to “1” if the employee agrees to the transfer, otherwise the field is left blank. The “Transfer Conditions” field records the transfer conditions for the transfer. For example, in the case of a married couple working for the same company, the transfer condition indicates a condition that the couple can only transfer if they both work at the same location.

The “No other member of family except spouse” field records information indicating whether the household to which the employee belongs is a two-people (the employee and his/her spouse) household. If the employee's household consists of only a married couple, “1” is stored in the “No other member of family except spouse” field; otherwise, the field is left blank.

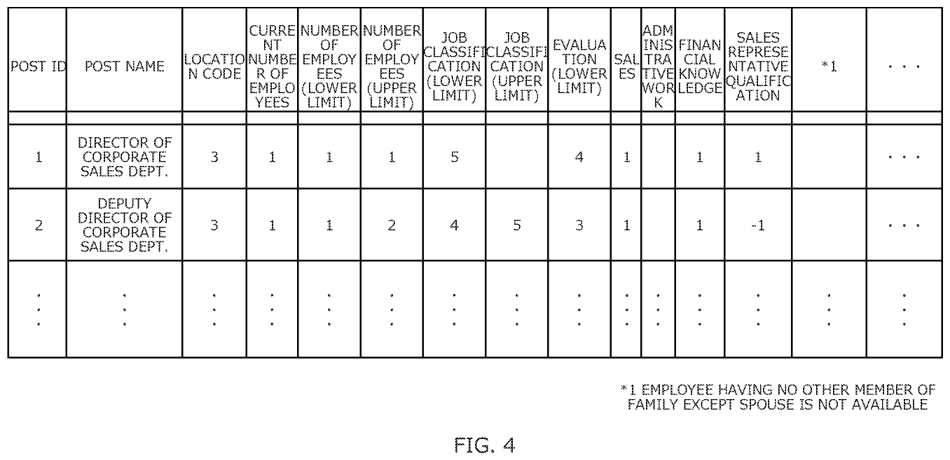

FIG. 4 shows an example of data in the personnel post database. In the database illustrated in FIG. 4, the following attributes of personnel posts are associated with each other: “post ID,” “post name,” “location code,” “current number of employees,” “number of employees (lower limit),” “number of employees (upper limit),” “job classification (lowest),” “job classification (highest),” “evaluation (lowest),” “sales,” “clerical work,” “financial knowledge,” “Sales Representative Qualification,” “Employee having no other member of family except spouse is not available”, etc. are associated with each other. Of these items, the “Post ID” field records an identifier (post ID) that identifies the combination of personnel post, i.e., department (branch) and position. The “Post Name” field records the name of the personnel post, i.e., the combination of the department name and the position name (e.g., “General Manager, Branch 00”). In the “Location Code” field, an identifier (location code) that identifies the department and branch is recorded. The “Number of Employees” field records the number of employees currently assigned to the department (branch) and position. The “Number of employees (minimum)” and “Number of employees (maximum)” fields record the minimum and maximum number of employees, who should be assigned to the department (branch) and position, respectively. The “Evaluation (Minimum)” field records the minimum evaluation required for an employee to be assigned to the position.

The “Sales” and “Administrative” fields record values indicating whether the personnel post is a sales post or an administrative post. If the personnel post is a sales post, “1” is recorded in the “Sales” field, and the “Administrative” field is left blank. On the other hand, if the personnel post is an administrative post, “1” is recorded in the “Administrative” field and the “Administrative” field is left blank.

The “Financial Knowledge” field records information indicating whether a given qualification in financial knowledge is mandatory for the personnel post. If the given qualification is mandatory or essential, “1” is recorded in this field, and if the given qualification is recommended, “−1” is recorded. On the other hand, if a given qualification is not required and is not recommended, the field is left blank.

The “Sales Representative Qualifications” field records information indicating whether a given Sales Representative personnel is mandatory for the personnel post. If the given qualification is mandatory, “1” is recorded in this field. If the given qualification is recommended, “−1” is recorded in this field. On the other hand, if a given qualification is not required and is not recommended, the field is left blank.

The “Married Couple Only” field records information indicating whether employees who belong to a married couple only household are prohibited from being assigned to that personnel post. In the case of an employee in a married couple only household, for example, assignment to a particular work location is prohibited for the employee in consideration of the mental burden on the spouse. If assignment to the work location is prohibited, “1” is recorded in this field. If assignment is not prohibited, the field is left blank.

There are two types of essential requirements that are referenced when a personnel change proposal is created: requirements for human resources and requirements for personnel posts. The essential requirements for human resources are requirements set for each human resource (e.g., employee). Information such as “transferable” and “transfer conditions” recorded in the employee database are examples of essential requirements related to human resources. The essential requirements for personnel posts are requirements set for each personnel post (e.g., branch manager, assistant branch manager, clerk, etc.). Information such as “Number of employees (lower limit),” “Number of employees (upper limit),” “Job classification (lowest),” “Job classification (highest),” “Evaluation (lowest),” “Sales,” “Administration,” “Financial knowledge,” “Sales Representative Qualification,” and “No married couples only household” recorded in the personnel post database are examples of essential requirements for personnel posts.

In addition, there are two types of optional requirements that are referenced when a personnel change plan is created: requirements for personnel and requirements for personnel posts. The optional requirements for human resources are requirements that are set for each human resource. The optional requirements are, for example, information such as “Employees who have been in their current personnel post for more than three years are recommended to move.” The optional requirements for personnel posts are requirements that are set for each personnel post. For example, an optional requirement for a personnel post is information such as “The deputy manager of the sales department should have a Sales Representative Qualification.”

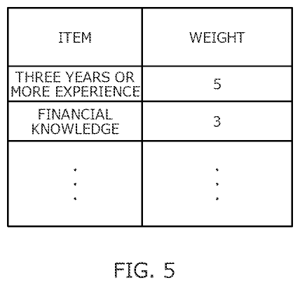

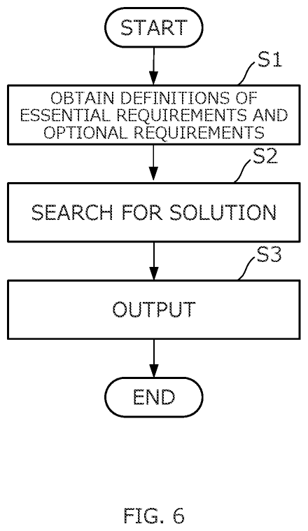

FIG. 5 shows an example of the contents of an optional requirement. The optional requirements include plural items and weight coefficients corresponding to each of the plural items. In the example of FIG. 5, weight coefficients are set for each of the multiple items included in the optional requirement.

The definitions of the objective function and the cost function are stored in the memory 11. The objective function is a function that quantifies the variation of the attributes of plural personnel in a proposed personnel change in plural personnel posts. The objective function is, for example, a function that quantifies the variation of at least one of the attributes of the plural personnel in terms of evaluation, years of employment, and age. In this embodiment, the personnel post is classified relating to plural departments and branches by location codes, and the objective function is a function that quantifies the variation of attributes in the plural departments and branches. For example, the sum or average of the variance of each employee's evaluation for each location (branch) indicated by the location code is used as the value indicating the variability.

The cost function is a function that quantifies the degree to which a personnel transfer proposal satisfies the optional requirements. In the following description, to provide a simple explanation, the value calculated by the cost function is referred to as the “conformity value.” In this embodiment, the degree of conformity is calculated using the weight coefficients of each of the multiple items included in the optional requirements. The greater the degree to which the optional requirement is satisfied, the closer the value of the conformity value is to zero.

The search unit 12 searches for a solution that optimizes (in this example, minimizes) the sum of the objective function and the cost function while satisfying the essential requirements. The output unit 13 outputs the solution found by the search unit 12 as a personnel change proposal. The back-calculating means 14 calculates the weight coefficient in the cost function backward by inputting the personnel change data in the past.

### 2. Operation

FIG. 6 is a flowchart illustrating an overview of the operation of the support device 10. In step S1, the support device 10 obtains the definitions of essential requirements, optional requirements, objective function, and cost function from the personnel database. The objective function, as described above, is a function that quantifies the variation of the attributes of the plural human resources in the proposed personnel changes across the plural personnel posts. The cost function is a function that quantifies the degree to which a proposed personnel change satisfies the optional requirements.

In step S2, the support device 10 searches for a solution that optimizes the sum of the obtained objective function and cost function while satisfying the essential requirements obtained in step S1. In this example, the support device 10 uses the information recorded in the employee database and the information recorded in the personnel post database to create a coefficient matrix indicating the positions that each employee can move to. Next, the support device 10 creates plural personnel transfer proposals (candidates) using the created coefficient matrix, and searches for a solution that optimizes the sum of the objective function and the cost function from among the multiple personnel change proposals (candidates). This search is nothing but a solving of a problem, for example, solving a so-called “optimization problem (or mathematical planning problem).” The “sum of the objective function and the cost function” in this case can be considered to correspond to the “objective function” in the usual sense of the term in optimization problems. Various algorithms for solving optimization problems have been studied, and any algorithm may be used to search for a solution.

In step S3, the support device 10 outputs the solution found by the search in step S2 as a personnel change proposal.

### 2-1. First Operation Example

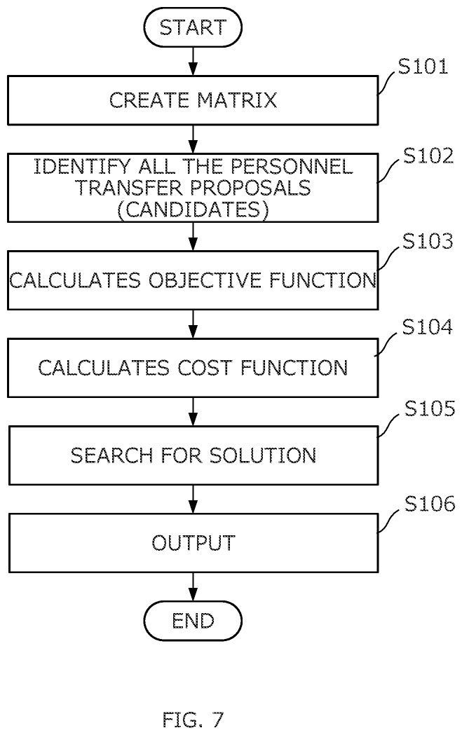

FIG. 7 is a flowchart illustrating the detailed operation of the support device 10. Although specific parameters and formulae are used here for explanation, these are only examples and the invention is not limited thereto. In step S101, the search unit 12 creates an n×m matrix C=(cij) as a coefficient matrix indicating the positions to which each employee can move, using the employee database and the personnel post database stored in the storage method 11.

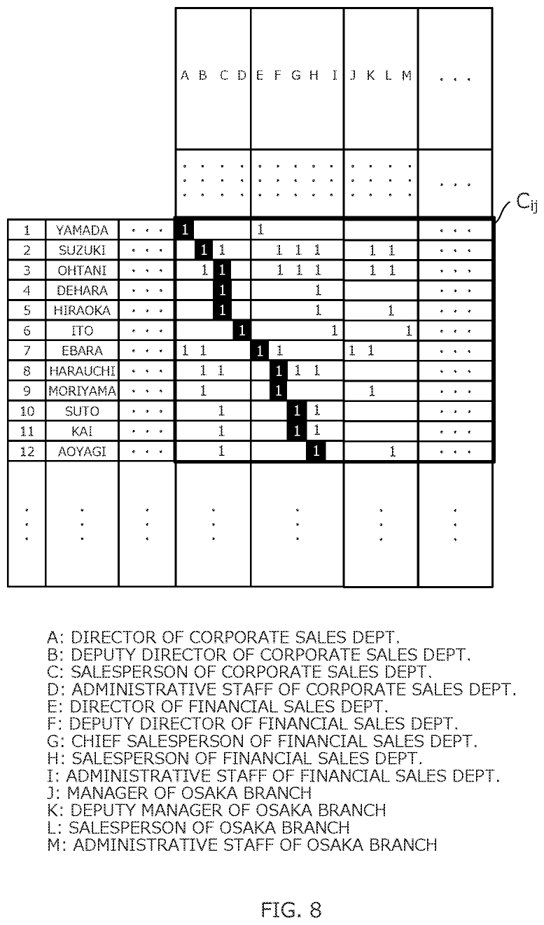

FIG. 8 shows an example of data in the coefficient matrix C. In the coefficient matrix C, n is the number of employees registered in the employee database, and m is the number of personnel posts registered in the personnel post database. In the coefficient matrix C, row i (i is a natural number satisfying 1≤i≤n) indicates the employee whose employee ID is i (hereinafter referred to as employee (i)) registered in the employee database. Column j (where j is a natural number satisfying 1≤j≤m) indicates the personnel post whose personnel post ID is j (hereinafter referred to as post (j)), which is registered in the personnel post database. In FIG. 8, the component cij, with “1” highlighted in black and white, represents the current placement. In other words, it indicates that employee (i) is currently serving in post (j). The n×m matrix x=(xij), which represents the current assignment, is defined as a matrix in which each component xij is 1 only when employee (i) is working at post (j), and 0 otherwise.

The search unit 12 determines for the employee (i) whether the essential requirements for the post (j) are satisfied (i.e., whether the employee is capable of serving in that personnel post) by referring to the employee database and the personnel post database. If the essential requirements are met, the search unit 12 sets the value of the component cij to “1”. In other words, the search unit 12 sets up the bits of the component cij. On the other hand, if the requirements are not met, the search unit 12 leaves the value of the component cij at zero. For example, the search unit 12 first identifies the target employees (fixing the parameter i), and then scans each personnel post (scanning the parameter j) to make the above decision. Next, the search unit 12 updates the target employees (updates the parameter i) and repeats the above process until the decision is completed for all employees. For employees or personnel posts that must be transferred, the difference between the row or column and the initial value may be taken and the value set to “zero.” Judgments are made for all components cij of the coefficient matrix C, and the coefficient matrix C illustrated in FIG. 8 is obtained.

The description refers to FIG. 7 again. In step S102, the search unit 12 uses the coefficient matrix C to identify all the personnel transfer proposals (candidates) that satisfy the essential requirements. The candidate personnel changes are represented by a matrix in which the component with a value of “1” in the coefficient matrix C is reduced to “one” in each row and column. In this way, multiple personnel change proposals (candidates) are identified.

In step S103, the search unit 12 calculates the value of the objective function for each of the plural personnel transfer proposals (candidates) identified in step S102. In one example, the objective function O is expressed by the following equation (1).

$$O = {\sum }_{v} \{ k ( v ) \cdot \frac{1}{d} {\sum }_{l} {[ v ( l ) - {μ}_{v} ]}^{2} \} \qquad ( 1 )$$

Here, v(l) represents the average value of the parameter to be evaluated (e.g., evaluation, years of service, or age) in branch l. d represents the number of branches. μv represents the value of v(l) averaged over l=1, . . . , d. The symbol Σ in front of the square brackets means that the results in the square brackets are added together for all the branches. k(v) represents the weight factor by which to multiply the parameter. The symbol Σ at the beginning of Equation (1) means that the results in square brackets are added together for multiple parameters. There may be only one parameter to be considered in the objective function. In that case, the Σ at the beginning of Equation (1) is not necessary.

The objective function illustrated in Equation (1) is a function for minimizing the variation of parameters among departments and branches. However, the objective function is not limited to a function for minimizing the variation of parameters among departments and branches. For example, the objective function may be one that minimizes (or maximizes) the number of people transferred. Here is an example of minimizing the number of people transferred. If the vector x=(xij) represents the current personnel assignment and the vector z=(zij) represents the personnel assignment after the transfer, the number of people transferred “nmove” is represented by the following equation (2).

nₘₒᵥₑ=n−(x,z) (2)

Here, n represents the number of employees registered in the employee database, and (x, z) represents the value obtained by treating the matrices x and z as vectors and taking the inner product. i is a natural number satisfying 1≤i≤n, and j is a natural number satisfying 1≤j≤m (m represents the number of personnel posts).

Equation (2) can also be expressed as equation (3).

$${n}_{move} = n - {\sum }_{i , j} {x}_{ij} {z}_{ij} \qquad ( 3 )$$

The number of people transferred “nmove” expressed in equation (2) or (3) may be used as the objective function, or the function in equation (1) and the function in equation (2) or (3) may be multiplied by coefficients, respectively, and added together.

Since the variance calculated in equation (1) is not linear, maximization of the “minimum value of the average of the performance of each department and branch” may be employed as a means of suppressing the scattering of parameters. This is equivalent to preparing the real variable s and solving the following problem.

maximize s subject to s≤v(l) for all l (4)

Here, v(l) is the average value of the consideration in each department branch l. If there are multiple parameters to be averaged, the objective function may be changed by multiplying and adding the weight coefficients as in Equation (1). In that case, the real variables sv for the parameters v are prepared, and the following equation (5) is considered.

$$maximize {\sum }_{v} k ( v ) {s}_{v} subject to {s}_{v} \leq v ( l ) for all v and l \qquad ( 5 )$$

In this case, v(l) represents the average value of the parameters to be evaluated (e.g., consideration, years of employment, or age, as considered in the example above), not just the consideration of each department branch l.

Also, the objective function may be omitted in this example. In other words, only the cost function may be considered and optimized.

In step S104, the search unit 12 calculates the value of the cost function for each of the plural personnel transfer proposals (candidates) identified in step S102. In one example, the cost function Cst is expressed by the following equation (6).

$$Cst = {\sum }_{l} [ w ( i ) rpst ( i ) + {\sum }_{j} [ w ( j ) rpsn ( j ) \qquad ( 6 )$$

Here, rpst(i) indicates the degree to which the optional requirement for post (i) is satisfied. w(i) represents the weight coefficient of the optional requirement. rpsn(j) indicates the degree to which the optional requirement for personnel (j) is satisfied. w(j) represents the weight coefficient of the optional requirement. The “degree to which an optional requirement is satisfied” is either “zero” or “one,” for example, for a requirement that takes only two states, “satisfied” or “not satisfied” (for example, a condition regarding the availability of qualifications). For those requirements that can take many states (e.g., a condition such as “longer service is preferred”), they are quantified according to predetermined criteria (e.g., “zero” for more than 10 years of service, “1” for more than 5 years but less than 10 years, “2” for more than 2 years but less than 5 years, and “3” for less than 2 years). In this exemplary operation, the cost function is defined so that the higher the degree to which the optional requirements are met, the smaller is the value. The coefficients in equations (1) and (2) are determined at a point in time prior to the start of the flow in FIG. 7, and are stored, for example, in the storage unit 11. In addition to the definitions of the objective function and the cost function, the search unit 12 reads the values of the coefficients used in these functions from the storage unit 11 and uses the values.

In step S105, the search unit 12 searches for a solution that optimizes the sum of the objective function and the cost function. For example, the search unit 12 calculates the sum of the objective function and the cost function for each of the plural personnel change proposals (candidates) created in step S102, and selects as a solution from among these personnel change proposals (candidates) the one that minimizes (or is closest to zero) the sum of the objective function and the cost function.

In order to facilitate the understanding of the present invention, we have explained the process of first identifying all the personnel change proposals (candidates), calculating the objective function and cost function separately, and searching for the solution that minimizes the sum. However, the algorithm to search for a solution that optimizes the sum of the objective function and the cost function is not limited to this example. In general, various algorithms for solving optimization problems are known, and any of the algorithms may be employed in the support device 10. Alternatively, machine learning or AI technologies such as neural networks or deep learning may be used to obtain this solution.

In step S106, the output unit 13 outputs the solution found by the search unit 12 as a personnel change proposal. The person in charge of the personnel change, etc., will refer to the personnel change proposal output from the support device 10. The person in charge may manually revise the output personnel change plan as required.

According to this example, it is possible to easily (automatically) generate a personnel change proposal that takes into account not only essential requirements but also optional requirements, using an already established personnel database.

### 2-2. Second Operation Example

In the first operation example, an example in which the values of the coefficients used in the objective function and cost function have already been determined, was explained. Although it is preferable that the values of these coefficients be set individually according to the situation of each company that is a user of the support system 10, especially for users who have introduced the support system 10 for the first time, it may not be clear what specific values should be set for the coefficients when the users first try to have the system create a personnel change plan. This is the case in the Second Operation Example. The Second Operation Example addresses such a problem. Specifically, in the Second Operation Example, a past personnel change proposal that has already been implemented (the most recent personnel change proposal, for example) is input, and the support device 10 calculates the weight coefficients backward from this input.

When calculating the weight coefficient backward, the back-calculation unit 14 searches for the combination of coefficients that minimizes the objective function and cost function as the solution, using the personnel transfer data (combination of personnel and post) as the constant and the coefficients of arbitrary requirements as the variables (arguments). In other words, the constants and variables are reversed from the case of operation example 1. The inverse calculation process in this example is nothing but solving an optimization problem. Here, the same algorithm as in the solution search of operation example 1 may be used, or a different algorithm may be used.

This implementation can automatically determine the weight coefficients in the objective function and cost function used to create a personnel change proposal.

### 3. Modifications

The present invention is not limited to the embodiments described above, and various modifications are available. Some exemplary modifications are described below. Two or more items in the following modifications may be applied in combination.

(1) In the above-mentioned embodiment, when a person in charge manually revises the personnel change proposal output from the support device 10, the support device 10 may perform the inverse calculation of weight coefficients using the adjusted personnel change proposal. The accuracy of the weight coefficients is improved when the inverse calculation process is performed using the adjusted personnel change proposals.

In addition, the content of optional requirements may be changed by the person in charge or others when the person in charge or others make adjustments manually.

(2) In the above embodiment, a case where the support device 10 outputs a personnel transfer plan that assigns plural personnel to plural personnel posts, according to addition to the examples described above, the support device 10 can also be used, for example, for seating order at a year-end party or class division in schools and training programs.

(3) The functional configuration of the support device 10 is not limited to that illustrated in FIG. 1. Some of the functions shown in FIG. 1 may be omitted, and functions not shown in the figure may be added. In addition, the functions implemented in the above-mentioned support device 10 may be shared and provided by multiple devices.

The order of processing performed by the 10 assistive devices is not limited to the examples described in the embodiments above. The steps of the processing may be interchanged as long as no contradiction occurs. The present invention may also be provided as a method of supporting personnel transfer performed by the support device 10.

The hardware configuration of the support device 10 is not limited to the one illustrated in FIG. 2. The hardware configuration of the support device 10 is not limited to the one illustrated in FIG. 2, but may include any hardware configuration as long as it can realize the required functions.

The functions of the above-mentioned support device 10 may be shared and implemented by multiple devices. For example, the functions of the above-mentioned support device 10 may be shared and implemented by a client terminal and a cloud server connected to the client terminal via communication lines, and the above-mentioned support device 10 may be configured as a system.

The program to be executed in the support device 10 may be provided by a non-transitory storage medium such as an optical disk, a magnetic disk, or a semiconductor memory, or may be downloaded via a communication line such as the Internet.

1. A personnel transfer support device comprising:
a storage unit that:
stores an employee database and a personnel post database, each corresponding to a specific organization; and
stores, for a personnel transfer proposal that assigns a plurality of personnel to a plurality of personnel posts, definitions of (a) essential requirements to be satisfied by the personnel transfer proposal, (b) optional requirements that the personnel transfer proposal is recommended to satisfy, and (c) a cost function that quantifies a degree to which the personnel transfer proposal satisfies the optional requirements;
a personnel change proposal unit that creates plural change proposals using the employee database and the personnel post database;
a search unit that searches for a solution that minimizes a sum of an objective function and the cost function, from among the plural change proposals while satisfying the essential requirements; and
an output unit that outputs the solution found by the search unit as the personnel change proposal.

2. The personnel transfer support device according to claim 1, wherein
the cost function includes a plurality of items with respect to the optional requirement and weight coefficients corresponding to each of the plurality of items.

3. The personnel transfer support device according to claim 2, further comprising:
a back-calculation unit that calculates the weight coefficients in the cost function by inputting the personnel change data in the past, wherein
the search unit searches for the solution using the weight coefficients calculated backwards by the back-calculation unit.

4. The personnel transfer support device according to claim 1, wherein
the storage unit further stores a definition of the objective function that indicates the following: (d) at least one of a function that quantifies the variation of the attributes of the plurality of personnel in the plurality of personnel posts in the proposed personnel change, and a function that shows the number of persons to be transferred in the proposed personnel change.

5. The personnel transfer support device according to claim 4, wherein
the objective function is a function that quantifies the variation in at least one of the following attributes of the plurality of human resources: job evaluation, years of employment, and age.

6. The personnel transfer support device according to claim 5, wherein
the personnel post is divided into a plurality of department branches, and
the objective function is a function that quantifies the variability of the attributes in the plurality of branches.

7. A method for supporting personnel transfer, comprising:
storing, by a computer system, an employee database and a personnel database, each corresponding to a specific organization;
obtaining, by a computer system, for a personnel transfer proposal that assigns a plurality of personnel to a plurality of personnel posts, definitions of (a) essential requirements that the personnel transfer proposal must satisfy, (b) optional requirements that the personnel transfer proposal is recommended to satisfy, and (c) a cost function that quantifies the degree to which the personnel transfer proposal satisfies the optional requirements;
creating, by the computer system, plural personnel change proposals using the employee database andthe personnel post database;
searching, by the computer system, for a solution that minimizes a sum of an object function and the cost function, from among the plural change proposals while satisfying the essential requirements; and
outputting, by the computer system, the solution found by the search as a personnel change proposal.

8. A program causing a computer to execute a process, the process comprising:
storing an employee database and a personnel database, each corresponding to a specific organization;
obtaining for a personnel transfer proposal that assigns a plurality of personnel to a plurality of personnel posts, definitions of (a) essential requirements that the personnel transfer proposal must satisfy, (b) optional requirements that the personnel transfer proposal is recommended to satisfy, and (c) a cost function that quantifies the degree to which the personnel transfer proposal satisfies the optional requirements;
creating plural personnel change proposals using the employee database and the personnel database;
searching for a solution that minimizes a sum of an object function and the cost function, from among the plural change proposals while satisfying the essential requirements; and
outputting the solution found by the search as a personnel change proposal.

9. The personnel transfer support device according to claim 2, wherein
the storage unit further stores a definition of the objective function that indicates the following: (d) at least one of a function that quantifies the variation of the attributes of the plurality of personnel in the plurality of personnel posts in the proposed personnel change, and a function that shows the number of persons to be transferred in the proposed personnel change.

10. The personnel transfer support device according to claim 9, wherein
the objective function is a function that quantifies the variation in at least one of the following attributes of the plurality of human resources: job evaluation, years of employment, and age.

11. The personnel transfer support device according to claim 10, wherein
the personnel post is divided into a plurality of department branches, and
the objective function is a function that quantifies the variability of the attributes in the plurality of branches.

12. The personnel transfer support device according to claim 3, wherein
the storage unit further stores a definition of the objective function that indicates the following: (d) at least one of a function that quantifies the variation of the attributes of the plurality of personnel in the plurality of personnel posts in the proposed personnel change, and a function that shows the number of persons to be transferred in the proposed personnel change.

13. The personnel transfer support device according to claim 12, wherein
the objective function is a function that quantifies the variation in at least one of the following attributes of the plurality of human resources: job evaluation, years of employment, and age.

14. The personnel transfer support device according to claim 13, wherein
the personnel post is divided into a plurality of department branches, and
the objective function is a function that quantifies the variability of the attributes in the plurality of branches.

15. The personnel transfer support device according to claim 1, wherein
the cost function includes a term relating to the optional requirement for the personnel post.

16. The personnel transfer support device according to claim 1, wherein
the cost function includes a term relating to the optional requirement for the personnel.

17. The method for supporting personnel transfer according to claim 7, wherein
the cost function includes a term relating to the optional requirement for the personnel post.

18. The method for supporting personnel transfer according to claim 7, wherein
the cost function includes a term relating to the optional requirement for the personnel.

19. The program causing the computer to execute the process according to claim 8, wherein
the cost function includes a term relating to the optional requirement for the personnel post.

20. The program causing the computer to execute the process according to claim 8, wherein
the cost function includes a term relating to the optional requirement for the personnel.
